(19) United States
(12) Patent Application Publication
(10) Pub. No.: US 2015/0072062 A1
(43) Pub. Date: Mar. 12, 2015

(54) SOURSOP LEAF DRINK AND METHOD OF MAKING SAME

(71) Applicant: AMAZING SOUR SOP INC., Coral Springs, FL (US)

(72) Inventor: Dennis Delano GRANT, Coral Springs, FL (US)

(21) Appl. No.: 14/530,000

(22) Filed: Oct. 31, 2014

Related U.S. Application Data
(60) Provisional application No. 61/898,167, filed on Oct. 31, 2013.

(51) Int. Cl. A23F 3/18; A23F 3/40

(52) U.S. Cl. CPC A23F 3/18; A23F 3/405
USPC 426/597

(57) ABSTRACT

A soursop drink and methods of producing a soursop drink are described. The method involves (a) providing soursop leaves; (b) treating the soursop leaves with heated, moist air or heated water to produce heat treated soursop leaves; (c) pressing the heat treated soursop leaves through one or more filters to produce a soursop leaf solution and (d) combining the soursop leaf solution with one or more additional ingredients such as ginger and/or cinnamon to produce a soursop leaf drink. The soursop leaf drink may also contain honey or other suitable sweetener.

### FIELD OF THE INVENTION

This invention relates to the field of food products. In particular, this invention relates to a soursop leaf drink and methods of producing a soursop leaf drink.

### BACKGROUND OF THE INVENTION

Soursop is the fruit of Annona muricata, a broadleaf, flowering, evergreen tree native to Mexico, Cuba, Central America, the Caribbean, and northern South America, primarily Colombia, Brazil, Peru, Ecuador, and Venezuela. Soursop is also produced in some parts of Africa, Southeast Asia and the Pacific. It is in the same genus as the chirimoya and the same family as the pawpaw.

The plant is grown as a commercial herb crop for long, prickly, green fruit. The flesh of the fruit consists of an edible, white pulp, some fiber, and a core of indigestible, black seeds. The sweet pulp is used to make juice, as well as candies, sorbets, and ice cream flavorings.

In Mexico, Colombia, Venezuela, and Harar (Ethiopia), it is a common fruit, often used for dessert as the only ingredient, or as an agua fresca beverage; in Colombia and Venezuela, it is a fruit for juices, mixed with milk. Ice cream and fruit bars made of soursop are also very popular.

In Indonesia, dodol sirsak, a sweetmeat, is made by boiling soursop pulp in water and adding sugar until the mixture hardens. Soursop is also a common ingredient for making fresh fruit juices that are sold by street food vendors. In the Philippines, it is called guyabano, derived from the Spanish guanabana, and is eaten ripe, or used to make juices, smoothies, or ice cream. Sometimes, they use the leaf in tenderizing meat.

Usually the fruits are taken from the tree when they mature and left to ripen in a dark corner, whereby they will be eaten when they are fully ripe. It has a white flower with a very pleasing scent, especially in the morning.

The leaves are also commonly used to make tea. However, a drink containing soursop leaves is not commercially available. Therefore, there is a need to provide a soursop drink having a color, taste and consistency pleasing to consumers.

### SUMMARY OF THE INVENTION

In order to meet this need, the present application is directed to a soursop leaf drink having a color, taste, and consistency pleasing to consumers.

The present application is directed to a method of producing a soursop leaf drink by (a) providing soursop leaves; (b) treating the soursop leaves with heated, moist air or heated water to produce heat treated soursop leaves; (c) optionally pressing the heat treated soursop leaves through one or more filters to produce a soursop leaf solution, and (d) combining the soursop leaf solution with one or more additional ingredients such as ginger and/or cinnamon to produce a soursop leaf drink. Preferably, the soursop leaf drink may also contain honey or other suitable sweetener.

The soursop leaves provided to produce the soursop leaf drink may be whole leaves, cut leaves, chopped leaves, sliced leaves, fresh leaves, frozen leaves, canned leaves or combinations thereof.

The soursop leaf drink of the application may contain one or more additional acids. The acids may be added prior to, during or after the pressing of the soursop leaves. Acids that find use in the soursop leaf drink include ascorbic acid, isoascorbic acid, malic acid, citric acid, fumaric acid, tartaric acid, propionic acid, acetic acid and lactic acid.

In the method of the present application the soursop leaves may be treated with heated, moist air or heated water. The heated, moist air or heated water may range in temperature from about 160° F. to about 210° F., preferably 185° F. The soursop leaves may be treated for a period of about 2 minutes, preferably 1 minute.

In the method of the present application the soursop leaves may be treated with acidified heated, moist air or acidified heated water. The acidified, heated moist air or the acidified heated water may range in temperature from about 160° F. to about 210° F., preferably 185° F. The soursop leaves may be treated for a period of about 2 minutes, preferably 1 minute. The acidified heated, moist air or acidified heated water may be acidified with one or more acids chosen from ascorbic acid, isoascorbic acid, malic acid, citric acid, fumaric acid, tartaric acid, propionic acid, acetic acid and lactic acid.

According to a preferred embodiment, the soursop leaves are pressed through one or more filters to produce a soursop leaf solution. The filters may have a screen size ranging from about 0.01 inches to about 0.75 inches.

The present application is also directed to a method of producing a soursop leaf drink wherein the soursop leaf drink is decanted.

In the method of the present application, one of more additional ingredients is added to the soursop leaf solution. The one or more additional ingredients may be chosen from, but is not limited to ginger and/or cinnamon. The one or more additional ingredients may be added at any point after, or while, the soursop leaves are treated with heated, moist air or heated water.

The present application is further directed to a method of producing a soursop leaf drink wherein the soursop leaf drink contains one or more sweeteners. The one or more sweeteners may be natural sweeteners such as unrefined brown sugar, maple syrup, molasses, barley malt, rice syrups, honey, agave nectar or combinations thereof. The amount of sweetener added is determined based on the desired taste to be obtained.

The soursop leaf drink of the invention may be combined with juices such as lemon, orange, apple, pear, peach, grape, grapefruit, other juices or blends thereof

The present application is further directed to a method of producing a soursop leaf drink wherein the soursop leaf drink is heat pasteurized.

The present application is further directed to a method of producing a soursop leaf drink wherein the soursop leaf drink is hot filled into storage containers.

The present application is further directed to a soursop leaf drink produced by the methods of the present application.

The present application is also directed to food products produced using the soursop leaf drink produced by the methods of the present application. Such food products include, but are not limited to beverage blends, frozen drink concentrates and syrups.

### DETAILED DESCRIPTION OF THE INVENTION

The present application is directed to a soursop leaf drink and methods of producing a soursop leaf drink.

A soursop leaf drink as herein defined is a food beverage including the extract of soursop leaves. The soursop leaf drink of the present application may include additional water from a heated, moist air or heated water treatment, additional acids, additional ingredients, and/or sweeteners.

The soursop leaf drink of the application is primarily produced from soursop leaves. Fresh, whole soursop leaves are preferred; however, canned, dried or frozen soursop leaves can also be used. The soursop leaves may be substantially whole, cut, chopped, or sliced.

In one embodiment of the present application, one or more added acids are utilized in the production of the soursop leaf drink. More or less additional acid is required to obtain a pH of less than 4.00. The pH can be determined through a number of well-known means, including using a pH meter, pH paper, and manual titration methods.

The one or more acids may be added as either a solid or as a solution. The one or more acids may be chosen from, but is not limited to ascorbic acid, isoascorbic acid, malic acid, citric acid, fumaric acid, tartaric acid, propionic acid, acetic acid and lactic acid, but any food-safe acid may be used.

In one embodiment, the one or more acids are added directly to the soursop leaves, prior to any additional processing. In another embodiment, the one or more acids are added after a heated moisture treatment step. In yet another embodiment, the one or more acids are introduced, in combination with the heated, moist air or heated water treatment step, by exposing the soursop leaves to acidified heated, moist air or acidified heated water. In an additional embodiment, the one or more acids are added immediately after a pressing step.

In the process of producing the soursop leaf drink of the present application, the soursop leaves are treated with heated, moist air or heated water. Heated, moist air or steam is air containing water particles. Such heated, moist air or steam is produced by heating water to produce heated, moist air or steam or by aerosolizing heated water. The heated, moist air or heated water treatment should generally be applied prior to pressing.

In one embodiment, the heated, moist air or heated water treatment is provided by exposing the soursop leaves to heated, moist air or heated water, at a temperature ranging from about 160° F. to about 210° F., preferably 185° F., for at least about 1 minute or more. The soursop leaves are exposed to heated, moist air or heated water at a temperature and for a sufficient time to extract the natural juice from the skin and flesh of the soursop leaves.

In yet another embodiment, the heated, moist air or heated treatment is performed by exposing the soursop leaves to acidified heated, moist air or acidified heated water, at a temperature ranging from about 160° F. to about 210° F., preferably 185° F. for at least about 1 minute or more. The heated, moist air or heated water is acidified by combining the one or more acids with water and heating the water. The one or more acids may be chosen from, but is not limited to ascorbic acid, isoascorbic acid, malic acid, citric acid, fumaric acid, tartaric acid, propionic acid, acetic acid and lactic acid. Treatment of the soursop leaves with heated, moist air or heated water results in heat treated soursop leaves. Heat treated soursop leaves generally retain some of the moisture from the heated, moist air or heated water.

The heat treated soursop leaves are optionally pressed after the heated, moist air or heated water treatment. Pressing involves macerating the soursop leaves and filtering the soursop leaves through one or more screens, also known as finishers, the filtering may be facilitated by applying pressure to the macerated soursop leaves. A finisher is a perforated screen of varying size used to filter the macerated soursop leaves, trapping certain solid pieces of leaves, breaking down other solid pieces of leaves, and yielding a soursop leaf solution. The number, and size, of the finishers used can be adjusted according to the level of filtration desired. In one embodiment, the filtering is performed using one or more filters, wherein each of the filters is a screen with openings ranging from 0.01 inches to 0.75 inches. Pressing the heat treated soursop leaves results in a soursop leaf solution.

In the method of the present application, additional ingredients are added to the soursop leaf drink. Such additional ingredients include, but are not limited to, ginger and cinnamon. The additional ingredient may be added at any point after the heated, moist air or heated water treatment. Any food safe additional ingredient may be added.

The quantity of additional ingredients varies depending on the taste desired. Sufficient additional ingredients should be added to achieve the desired taste. One skilled in the art can readily ascertain the quantity required based on specifications provided for the desired taste. In one embodiment, the one or more additional ingredients are combined with the soursop leaf solution then heated and maintained at about 160° F. to about 195° F. for a period of about 1 minute to about 5 minutes. Alternatively, the additional ingredients may be added to the heated soursop leaf solution. In one embodiment, the additional ingredients are ginger and cinnamon, added in a ratio of about 0.04 oz. to about 0.12 oz. and about 0.01 oz. to about 0.11 oz per 10 oz drink.

In yet another embodiment, the soursop leaf solution is decanted after pressing. Decanting involves storing the soursop leaf solution in a first container and allowing sufficient time for solids to settle near the bottom. The solution is then gradually transferred to a second container, while leaving a substantial portion of the solids in the first container. Decanting is a means by which viscosity of the drink is regulated.

It is also desirable to maintain consistent flavoring in a soursop leaf drink. In one embodiment of the present application, one or more sweeteners are added to the soursop leaf drink, in order to provide a soursop leaf drink with consistent taste. Addition of one or more sweeteners is only required if desired; in some circumstances no additional sweetener is required because an unsweetened soursop leaf drink is desired. The one or more sweeteners may be added as either a solid or as a solution. The one or more sweeteners may be added either before or after the additional ingredients.

The one or more sweeteners may a natural sweetener. The natural sweeteners include, but are not limited to unrefined brown sugar, maple syrup, molasses, barley malt, rice syrups, honey, agave nectar or combinations thereof. Any food safe sweetener may be used.

The amount of one or more sweeteners added, depending on the sweetness desired. In one embodiment, the added sweetener is honey. In another embodiment, the amount of honey added per weight is equal to the amount of soursop leaves added per weight.

In some circumstances, it is desirable to add additional acid or acids in addition to the sweetener addition. Such acids can be added in an amount sufficient to provide a desired tartness and taste. The one or more acids may be chosen from, but is not limited to ascorbic acid, isoascorbic acid, malic acid, citric acid, fumaric acid, tartaric acid, propionic acid, acetic acid and lactic acid. In one embodiment, the acid is citric acid. In another embodiment, the acid is malic acid.

The soursop leaf drink of the current application is highly adaptable to commercial production methods known in the art.

In one embodiment, the soursop leaf drink is heat pasteurized for sanitary purposes. Heat pasteurization involves heating the soursop leaf drink to a minimum temperature for a minimum amount of time, sufficient to kill harmful bacteria.

In another embodiment, the soursop leaf drink is hot filled into storage containers. Hot filling is a method known in the art for the purpose of minimizing bacterial contamination. Hot filling involves heating the soursop leaf drink to about 150° F. to about 195° F., and maintaining the temperature until the soursop leaf drink is packaged and sealed.

An example of the soursop leaf drink of the present application is a commercially packaged, soursop leaf drink including 88% water, 5% soursop leaves, 5% sweetener, additional ingredients and acids comprising the remaining 2%.

The soursop leaf drink of the present application may be combined with other juices. Such juices include, but are not limited to: lemon, orange, apple, pear, peach, grape, grapefruit and other juices and blends.

The soursop leaf drink of the present application may also be utilized in the production of food products. Examples of food products produced using the soursop leaf drink of the present application include, but are not limited to beverage blends, frozen drink concentrates and syrups.

The application will be better understood by reference to the following non-limiting example.

TABLE 1
For a 10 oz bottle of drink produced

| | |
|---|---|
| Water | 8.80 oz. |
| Honey | 0.50 oz. |
| Soursop leaves | 0.50 oz. |
| Ginger | 0.09 oz. |
| Cinnamon | 0.06 oz. |
| Citric acid | 0.05 oz. |

Soursop leaves are obtained. All the ingredients are combined and blended. The mixture is heated to 182° F. for 1 minute to obtain a drink with a pH of about 3.42. The drink is then heat pasteurized and hot filled at a temperature of at least 160° F., inverted and capped. Using the recommended/required thermal process, the microbiological shelf life of the finished product should be at least 2 years if the seal integrity of the bottle.

The drink may be clarified through decanting. Decanting removes a portion of the insoluble solids that contribute to the consistency, or body, of a soursop leaf drink. Decanting can be varied or even omitted, depending on the desired consistency.

The packaged soursop leaf drink is cooled, to a desired temperature, and the bottles are cased and palletized. The pallets of soursop leaf drink are stored at about 40° F., ready for delivery to retail outlets and consumers.

1. A method of producing a soursop leaf drink comprising the steps of:
a. providing soursop leaves;
b. treating the soursop leaves with heated, moist air or heated water to produce heat treated soursop leaves;
c. pressing the heat treated soursop leaves through at least one filter to produce a soursop leaf solution; and
d. adding at least one additional ingredient selected from the group consisting of ginger, cinnamon and mixtures thereof to produce a soursop leaf drink.

2. The method of claim 1, further comprising the step of adding at least one sweetener selected from the group consisting of natural and artificial sweeteners.

3. The method of claim 2, wherein the sweetener is selected from the group consisting of unrefined brown sugar, maple syrup, molasses, barley malt, rice syrups, honey, agave nectar and combinations thereof.

4. The method of claim 1, wherein the soursop leaves are selected from the group consisting of whole leaves, cut leaves, chopped leaves, sliced leaves, fresh leaves, frozen leaves, canned leaves and combinations thereof.

5. The method of claim 1, further comprising the step of adding at least one additional acid.

6. The method of claim 5, wherein the additional acid is selected from the group consisting of ascorbic acid, isoascorbic acid, malic acid, citric acid, fumaric acid, tartaric acid, propionic acid, acetic acid, lactic acid and mixtures thereof.

7. The method of claim 1, wherein the filter has a screen size ranging from about 0.01 inches to about 0.75 inches.

8. The method of claim 1, wherein the heated, moist air or heated water is at a temperature of about 160° F. to about 210° F.

9. The method of claim 1, wherein the soursop leaves are treated for a period of about 2 minutes.

10. The method of claim 1, wherein the soursop leaves are treated with acidified heated, moist air or acidified heated water, wherein the acidified, heated moist air or the acidified heated water is at a temperature in the range of about 160° F. to about 210° F. for a period of about 2 minutes.

11. The method of claim 1, further comprising the step of decanting the heat treated soursop leaves.

12. The method of claim 1, further comprising the step of adding a juice selected from the group consisting of lemon, orange, apple, pear, peach, grape, grapefruit and blends thereof.

13. The method of claim 1, further comprising the step of heat pasteurizing the soursop leaf drink.

14. The method of claim 1, further comprising the step of hot filling the soursop leaf drink into storage containers.

15. The method of claim 1, further comprising the step of using the soursop leaf drink to produce beverage blends, frozen drink concentrates or syrups.

16. A soursop leaf drink produced by the method claim 1.

17. The soursop leaf drink of claim 16, further comprising at least one sweetener selected from the group consisting of unrefined brown sugar, maple syrup, molasses, barley malt, rice syrups, honey, agave nectar and combinations thereof.

18. The soursop leaf drink of claim 16, further comprising at least one additional acid selected from the group consisting of ascorbic acid, isoascorbic acid, malic acid, citric acid, fumaric acid, tartaric acid, propionic acid, acetic acid, lactic acid and mixtures thereof.

19. The soursop leaf drink of claim 16, further comprising a juice selected from the group consisting of lemon, orange, apple, pear, peach, grape, grapefruit and blends thereof.

20. A soursop leaf drink produced by the method claim 1, further comprising at least one sweetener selected from the group consisting of unrefined brown sugar, maple syrup, molasses, barley malt, rice syrups, honey, agave nectar and combinations thereof, at least one acid selected from the group consisting of ascorbic acid, isoascorbic acid, malic acid, citric acid, fumaric acid, tartaric acid, propionic acid, acetic acid, lactic acid and mixtures thereof, and a juice selected from the group consisting of lemon, orange, apple, pear, peach, grape, grapefruit and blends thereof.
